(19) United States
(12) Patent Application Publication
(10) Pub. No.: US 2025/0164778 A1
(43) Pub. Date: May 22, 2025

(54) OPTICAL ARRANGEMENT GENERATING OVERLAPPING POLARIZED BEAMS FOR LIQUID-CRYSTAL-ON-SILICON (LCOS) BEAM STEERING

(71) Applicant: Lumentum Operations LLC, San Jose, CA (US)

(72) Inventors: Thomas FRIESSNEGG, Ottawa (CA); Paul Dwight COLBOURNE, Ottawa (CA); Kwun Sing CHAN, Ottawa (CA)

(21) Appl. No.: 18/415,029

(22) Filed: Jan. 17, 2024

Related U.S. Application Data
(60) Provisional application No. 63/601,387, filed on Nov. 21, 2023.

(51) Int. Cl. G02B 26/08; G02B 27/28; G02F 1/313

(52) U.S. Cl. CPC G02B 26/0825; G02B 27/283; G02F 1/3132

(57) ABSTRACT

An optical system includes a beam steering device configured with a beam-steering dependency dependent on a first polarization, and an optical arrangement comprising an input, a first optical path, and a second optical path, and an output. The first optical path and the second optical path extend from the input and intersect at a same point-of-incidence on the beam steering device. The optical arrangement is configured to split an input beam into two orthogonally polarized beams, direct a first polarized beam along the first optical path, and direct a second polarized beam along the second optical path. The optical arrangement is configured to provide the first polarized beam and the second polarized beam to the beam steering device as spatially-overlapped beams with a same polarization. The beam steering device is configured to steer the first polarized beam and the second polarized beam toward the output in a common output direction.

### CROSS-REFERENCE TO RELATED APPLICATION

This patent application claims priority to U.S. Provisional Patent Application No. 63/601,387, filed on Nov. 21, 2023, and entitled “PRISM ARRANGEMENT GENERATING OVERLAPPING POLARIZATION BEAMS FOR LCOS BEAM STEERING.” The disclosure of the prior application is considered part of and is incorporated by reference into this patent application.

### TECHNICAL FIELD

The present disclosure relates generally to polarized-dependent beam steering.

### BACKGROUND

A wavelength selective switch (WSS) is widely used for dynamic routing of wavelength channels in optical communications networks. WSS devices may be deployed in optical switching nodes of long-haul, regional, and metro optical communications networks.

Long-wavelength band and conventional band ranges are typically referred to as L band and C band, respectively. There is a growing demand for wide band (C+L band) and high port count WSS devices in the industry. These WSS devices need to allow for selecting a flexible optical channel width to be directed to an output. Setting a channel width of a channel, and beam steering of the channel, are usually accomplished by a liquid crystal on silicon (LCOS) chip. An LCOS is a miniaturized reflective active-matrix liquid-crystal display or “microdisplay” using a liquid crystal layer on top of a silicon backplane. The LCOS may also be referred to as a spatial light modulator or director array. LCOS-based beam steering typically requires that an incident beam has a single polarization orientation that is aligned to a direction in which the LCOS is operating.

### SUMMARY

In some implementations, an optical system includes a beam steering device configured with a beam-steering dependency dependent on a first polarization, wherein the beam steering device is configured to steer only light having the first polarization; and an optical arrangement comprising an input, a first optical path, and a second optical path, and an output, wherein the input is configured to receive an input beam with an arbitrary polarization state, and wherein the first optical path and the second optical path extend from the input and intersect at a same point-of-incidence on the beam steering device, wherein the optical arrangement further comprises: a first optical component configured to split the input beam into two orthogonally polarized beams including a first polarized beam and a second polarized beam, wherein the first optical component is configured to direct the first polarized beam along the first optical path with the first polarization, and direct the second polarized beam along the second optical path with a second polarization that is orthogonal to the first polarization; and a second optical component configured to receive the second polarized beam, rotate the second polarization of the second polarized beam into the first polarization, and direct the second polarized beam further along the second optical path with the first polarization, wherein the first optical component and the second optical component are configured such that the first polarized beam, with the first polarization, and the second polarized beam, with the first polarization, spatially overlap at the beam steering device, and wherein the beam steering device is configured to steer the first polarized beam and the second polarized beam toward the output such that the first polarized beam and the second polarized beam are directed from the output in a common output direction.

In some implementations, an optical system includes a beam steering device configured with a beam-steering dependency dependent on a linear polarization, wherein the beam steering device is configured to steer only light having the linear polarization; and an optical arrangement comprising an input, a first optical path, and a second optical path, and an output, wherein the input is configured to receive an input beam with an arbitrary polarization state, and wherein the first optical path and the second optical path extend from the input and intersect at a same point-of-incidence on the beam steering device, wherein the optical arrangement further comprises: a polarization grating arranged at the input and the output, wherein the polarization grating is configured to split the input beam into two orthogonally polarized beams including a first polarized beam having a left circular polarization and a second polarized beam having a right circular polarization, a first mirror comprising a first retarder, wherein the first mirror is arranged on the first optical path between the polarization grating and the beam steering device, wherein the first mirror is configured to convert the left circular polarization of the first polarized beam into the linear polarization, and direct the first polarized beam further along the first optical path with the linear polarization; and a second mirror comprising a second retarder, wherein the second mirror is arranged on the second optical path between the polarization grating and the beam steering device, wherein the second mirror is configured to convert the right circular polarization of the second polarized beam into the linear polarization, and direct the second polarized beam further along the second optical path with the linear polarization, wherein the beam steering device is configured to steer the first polarized beam and the second polarized beam toward the output such that the first polarized beam and the second polarized beam are directed from the output in a common output direction.

### BRIEF DESCRIPTION OF THE DRAWINGS

FIGS. 1A-1D show an optical system according to one or more implementations.

FIG. 2 shows an optical system according to one or more implementations.

FIG. 3 shows an optical system according to one or more implementations.

FIGS. 4A-4C show an optical system according to one or more implementations.

FIGS. 5A and 5B show input/output direction arrangements according to one or more implementations.

FIG. 6 shows an input/output direction arrangement according to one or more implementations.

### DETAILED DESCRIPTION

The following detailed description of example implementations refers to the accompanying drawings. The same reference numbers in different drawings may identify the same or similar elements.

In a WSS device, a polarization is usually selected in front-end optics of the WSS device (e.g., near the input/output fibers). This is done by, first, splitting an input beam into two orthogonal polarizations, and second, rotating one of the polarizations such that both beams have a same polarization. These beams are relayed to the LCOS through other optical components of the WSS device.

A WSS device may have a wavelength dispersion direction and a port switching direction that is perpendicular to the wavelength dispersion direction. In a case of splitting input beams in the wavelength dispersion direction of the WSS device, there are two beams incident on an aperture of a grating, which reduces a resolution by a factor of two, compared to not splitting the input beam into two polarizations. If the input beams are split in the port switching direction of the WSS device, a number of ports that can be fit within the aperture of the grating reduces by a factor of two.

A polarization-independent LCOS design eliminates a requirement of splitting the input beam into two polarizations, thus allowing for high port count and high resolution. Unfortunately, a polarization-independent LCOS is difficult to manufacture. Thus, there is a significant advantage to an alternative approach that can work with a polarization-dependent LCOS design.

Some polarization-dependent optical arrangements have additional disadvantages. For example, some polarization-dependent optical arrangements split incoming light into two beams (e.g., two polarizations), and the two beams have different propagation times. The different propagation times lead to a differential group delay (DGD), also called polarization mode dispersion (PMD). The DGD is unsuitable for processing light beams that have high bit rate modulation. In another example, incoming light may be split into two beams (e.g., two polarizations). However, due to a difference in a number of reflections between the two beams, the two beams are required to be steered by the LCOS in opposite directions in order to re-emerge from the WSS device with a same propagation direction. For example, this may occur when the difference in the number of reflections is an odd number. Steering the two beams in opposite directions may be done by writing different beam steering patterns to the two different areas or sections of the LCOS. As a result, the two beams need to be spatially separated from each other on the LCOS, for example, with no spatial overlap. A disadvantage of this approach is that space is needed on the LCOS for accommodating two spatially separated beams, which means that a size of each beam must be half of what a size could be when using only one beam. This in turn doubles a steering angle per port and reduces a total number of ports that can be addressed with a given steering angle range.

Some implementations described herein provide a WSS device that is configured to have a first beam and a second beam intersect at a same point on an LCOS. In other words, a first beam and a second beam substantially overlap, and in some cases entirely overlap, on the LCOS. As a result, a beam size of each beam can be as large as an entire LCOS (e.g., as large as an aperture of the LCOS), thereby minimizing a steering angle per port and maximizing a total number of ports in the WSS device. Thus, the WSS device may avoid limiting a total port count. In addition, an intersection angle may be in a beam steering direction (e.g., a port switching direction) so that a spectral resolution may be optimized.

Some implementations provide an optical system that may generate overlapping polarized beams for LCOS beam steering. The optical system may be provided in a WSS for port steering. The optical system may be configured to split an incoming unpolarized beam into two polarized beams with orthogonal polarizations (e.g., a first polarized beam and a second polarized beam), rotate the first polarized beam to have a same polarization state as the second polarized beam; cause the two polarized beams to intersect at a same area on the LCOS, with an intersection angle in a beam steering direction; have an equal focal distance within a tolerance margin for the two polarized beams; and have a same number of reflections in each beam path of the two polarized beams such that the two polarized beams can be steered by the LCOS in a same direction. Alternatively, a difference between a number of reflections of the two beam paths may be a multiple of two, such that the two polarized beams can be steered by the LCOS in a same direction.

“Focal distance” is defined (approximately, for elements with flat surfaces) as a sum of a material thickness divided by a refractive index. “Optical pathlength” is defined as a sum of material thickness multiplied by a refractive index. A focal point of both polarized beams can be made to lie in a plane of the LCOS, even though a physical length of each path may be different. Similarly, different refractive indices may be used to maintain a same optical pathlength for the two polarized beams. Thus, by making different parts of the optical system out of materials with different refractive indices, the focal distances for the two polarized beams can be made to be equal within a tolerance margin and the optical pathlengths for the two polarized beams can be made to be equal within a tolerance margin.

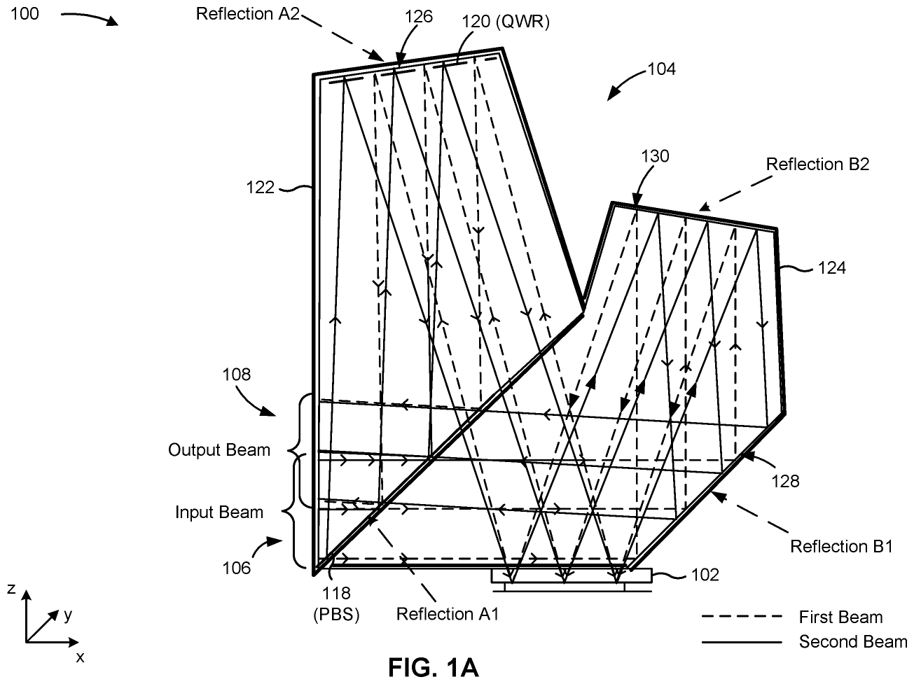

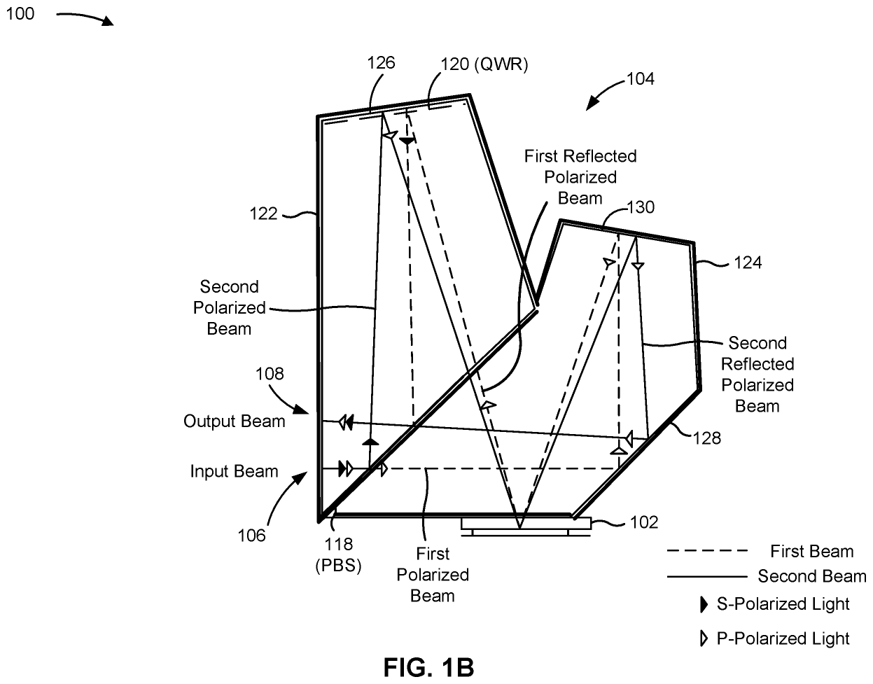

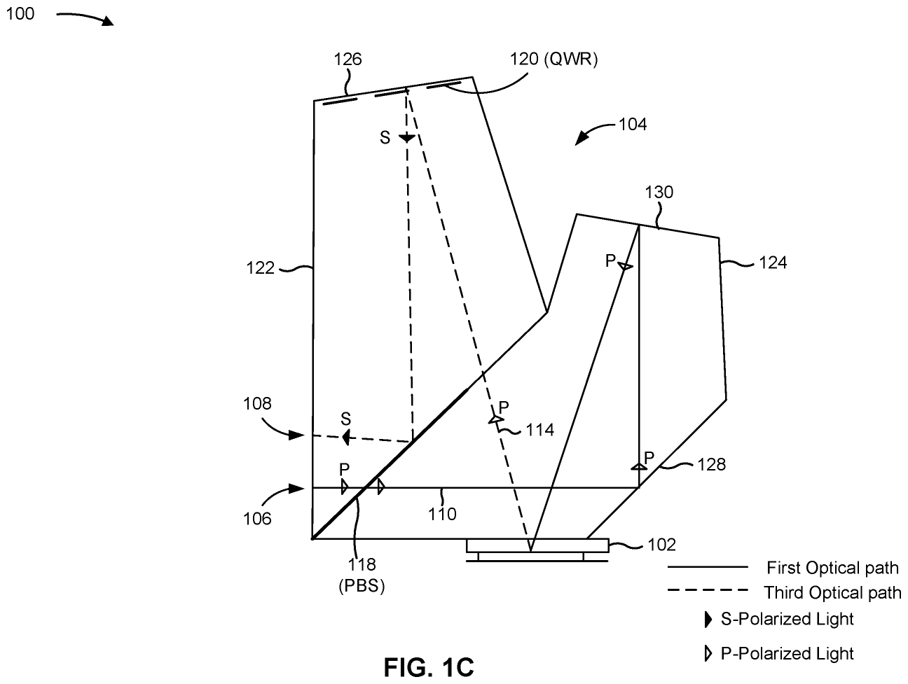

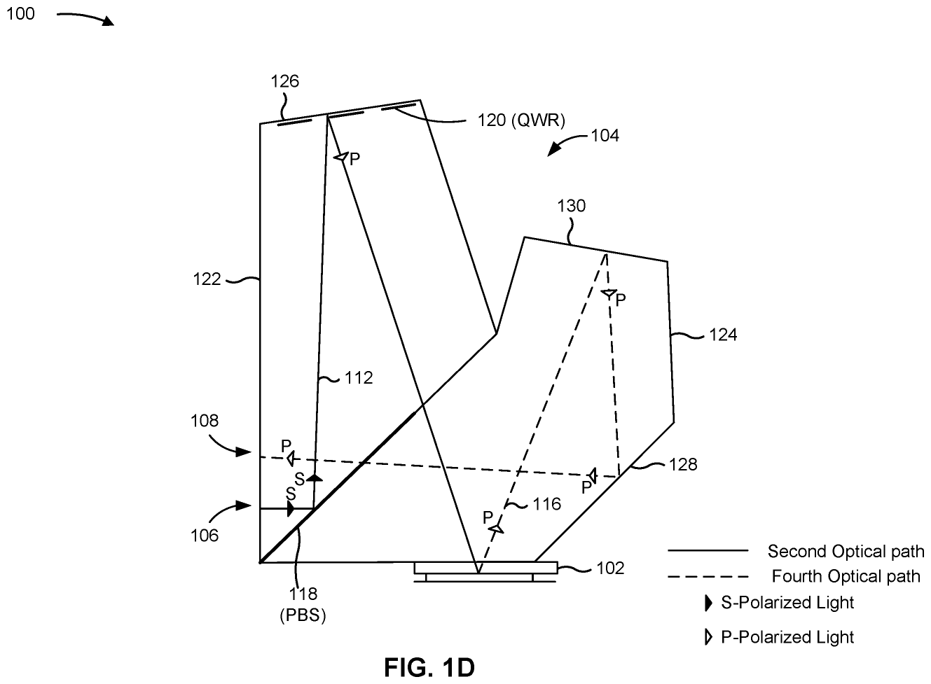

FIGS. 1A-1D show an optical system 100 according to one or more implementations. The optical system 100 may be implemented in a WSS device, for example, for port steering. A y-axis may correspond to a wavelength dispersion direction and a z-axis may correspond to a port switching direction. The optical system 100 may include a beam steering device 102 and an optical arrangement 104.

The beam steering device 102 may be configured with a beam-steering dependency dependent on a polarization, such as a P-polarization or an S-polarization. For example, the beam steering device 102 may be configured to steer only light having a first polarization (e.g., the P-polarization). In some implementations, the beam steering device 102 may be a polarization-dependent LCOS array, a polarization-dependent spatial light modulator, or a polarization-dependent light director array. The beam steering device 102 may be configured to steer two polarized light beams to a common output direction. However, in order to simultaneously steer the two polarized light beams, the two polarized light beams incident on the beam steering device 102 must have a same polarization orientation as the polarization in which the beam steering device 102 operates. Thus, if the beam steering device 102 is configured to steer light having the first polarization, the two polarized light beams must have the first polarization at the beam steering device 102.

The optical arrangement 104 may include a plurality of optical components configured to guide the two polarized light beams along respective optical paths. The optical arrangement 104 may include an input 106 (e.g., an optical input), an output 108 (e.g., an optical output), a first optical path 110 for a first polarized beam, a second optical path 112 for a second polarized beam, a third optical path 114 for the first polarized beam, and a fourth optical path 116 for the second polarized beam. FIG. 1A shows a trajectory of the first polarized beam, a first reflected polarized beam, the second polarized beam, and a second reflected polarized beam with actual beam widths. The first polarized beam and the second polarized beam substantially, if not fully, overlap at the beam steering device 102. FIG. 1B shows a trajectory of the first polarized beam, a first reflected polarized beam, the second polarized beam, and a second reflected polarized beam, with corresponding polarizations. The first reflected polarized beam is produced by reflection of the first polarized beam at the beam steering device 102. The second reflected polarized beam is produced by reflection of the second polarized beam at the beam steering device 102. FIG. 1C shows a trajectory of the first polarized beam on the first optical path 110, and the first reflected polarized beam on the third optical path 114. FIG. 1D shows a trajectory of the second polarized beam on the second optical path 112, and the second reflected polarized beam on the fourth optical path 116.

The input 106 may receive an input beam with an arbitrary polarization state (e.g., an unpolarized state). Thus, the input beam may contain P-polarized and S-polarized components (e.g., a first polarized beam and a second polarized beam). The first optical path 110 and the second optical path 112 may extend from the input 106 and intersect at a same point-of-incidence on the beam steering device 102. The third optical path 114 and the fourth optical path 116 may extend from the beam steering device 102 to the output 108, for example, after reflection at the beam steering device 102.

The optical arrangement 104 may include a first optical component 118 and a second optical component 120. The first optical component 118 may split the input beam into two orthogonally polarized beams (e.g., two orthogonal linear polarizations) including the first polarized beam and the second polarized beam. The first optical component 118 may direct the first polarized beam along the first optical path with the first polarization, such as a P-polarization. Additionally, the first optical component 118 may direct the second polarized beam along the second optical path with a second polarization, such as an S-polarization, that is orthogonal to the first polarization. In some implementations, the first optical component 118 may be a polarization beam splitter (PBS) arranged on the first optical path 110 and the second optical path 112.

The second optical component 120 may receive the second polarized beam, rotate the second polarization of the second polarized beam into the first polarization, and direct the second polarized beam further along the second optical path 112 with the first polarization. In other words, the second optical component 120 may convert the second polarization of the second polarized beam into the first polarization such that both the first polarized beam and the second polarized beam have the same polarization (e.g., the first polarization or P-polarization) at the beam steering device 102. In some implementations, the second optical component 120 may convert the second polarization of the second polarized beam into the first polarization by a 90-degree rotation of the second polarization. In some implementations, the second optical component 120 may be a quarter-wave retarder (QWR) or a half-wave retarder (HWR). In some implementations, a quarter-wave retarder may be a quarter-wave plate (QWP). In some implementations, a half-wave retarder may be a half-wave plate (HWP).

In addition, the first optical component 118 and the second optical component 120 are configured such that the first polarized beam, with the first polarization, and the second polarized beam, with the first polarization, spatially overlap at the beam steering device 102. The beam steering device 102 may steer the first polarized beam and the second polarized beam toward the output 108 such that the first polarized beam and the second polarized beam are directed from the output 108 in a common output direction. In other words, the beam steering device 102 may simultaneously receive and steer both the first polarized beam and the second polarized beam such that the first polarized beam and the second polarized beam are eventually combined by the optical arrangement 104 into a combined output beam that is output from the output 108 in the common output direction. The common output direction may depend on a beam steering angle of the beam steering device 102. When the optical arrangement 104 is implemented in a WSS device, the optical arrangement 104 may include additional optical components configured to collimate the first polarized beam and the second polarized beam in the port switching direction and focus the first polarized beam and the second polarized beam in the wavelength dispersion direction.

In some implementations, the first optical component 118 and the second optical component 120 may be configured such that the first polarized beam, with the first polarization, and the second polarized beam, with the first polarization, spatially overlap at the beam steering device 102. For example, at least 90% of a first area of the beam steering device 102 at which the first polarized beam is incident on the beam steering device 102 spatially overlaps with a second area of the beam steering device 102 at which the second polarized beam is incident on the beam steering device. In some implementations, the first optical component 118 and the second optical component 120 may be configured such that the first polarized beam, with the first polarization, and the second polarized beam, with the first polarization, completely spatially overlap at the beam steering device 102. The first polarized beam and the second polarized beam may fill or substantially fill an aperture of the beam steering device 102. In other words, a beam size of the first polarized beam and a beam size of the second polarized beam can be as large as an entire aperture size of the beam steering device 102.

Moreover, the first optical component 118 and the second optical component 120 may be configured such that the first polarized beam, with the first polarization, and the second polarized beam, with the first polarization, intersect at the same point-of-incidence with an intersection angle in a beam steering direction of the beam steering device 102. For example, the first polarized beam and the second polarized beam may be parallel to the x-z plane in FIG. 1A when they intersect at the beam steering device 102.

In some implementations, the optical arrangement 104 may have an equal or substantially equal focal distance (e.g., within a tolerance margin) for the first polarized beam and the second polarized beam. For example, the optical arrangement 104 may focus the first polarized beam onto the beam steering device 102, in the wavelength dispersion direction, within a first depth of focus, and the optical arrangement 104 may focus the second polarized beam onto the beam steering device 102, in the wavelength dispersion direction, within a second depth of focus. As a result, the focal distances for the two polarized beams can be made to be equal within a tolerance margin such that both the first polarized beam and the second polarized beam are in focus at the beam steering device 102. In some implementations, the first depth of focus may be equal to or substantially equal to the second depth of focus. Additionally, or alternatively, a first optical pathlength travelled by the first polarized beam from the input 106 to the output 108 may be equal or substantially equal to a second optical pathlength travelled by the second polarized beam from the input 106 to the output 108.

Moreover, the optical arrangement 104 may be configured such that the first optical path 110 has a first number of reflections, and the second optical path 112 has a second number of reflections that is equal to the first number of reflections. Alternatively, a difference between the first number of reflections and the second number of reflections may be a multiple of two. As a result, the first polarized beam and the second polarized beam may spatially overlap at the beam steering device 102, and both the first polarized beam and the second polarized beam may be provided to the output 108 by the optical arrangement 104 in a common output direction.

In some implementations, the beam steering device 102 may be configured to reflect the first polarized beam such that the first polarized beam retraces the second optical path 112, and reflect the second polarized beam such that the second polarized beam retraces the first optical path 110. For example, when no active beam steering is being performed by the beam steering device 102 (e.g., during a zero-order reflection), the first polarized beam may retrace the second optical path upon being reflected by the beam steering device 102, and the second polarized beam may retrace the first optical path 110 upon being reflected by the beam steering device 102. Orders of reflection may be referred to as diffraction orders. “Zero-order reflection” (e.g., a zero-order diffraction) may refer to a reflection of a non-diffracted beam by the beam steering device 102. In other words, a zero-order reflection may represent a beam path when there is no grating displayed or written on the beam steering device 102 (e.g., on the LCOS array). In contrast, a first-order reflection (e.g., a first-order diffraction) may occur during active steering by the beam steering device 102. “First-order reflection” may refer to a reflection of a diffracted beam by the beam steering device 102. In other words, a first-order reflection may represent a steered beam path when there is a grating displayed or written on the beam steering device 102 (e.g., on the LCOS array). Higher order reflections or negative order reflections may occur when there is a grating displayed or written on the beam steering device 102 and there is diffracted light in unwanted directions (e.g., at unwanted diffracted angles). Thus, a positive first-order reflection may represent a wanted or a desired reflection in an intended beam steering direction (e.g., at a desired diffracted angle), whereas a negative first-order reflection or a second-order reflection may represent an unwanted or undesired reflection.

Alternatively, the optical arrangement 104 may be configured to direct the combined output beam of a zero-order reflection to have a different position and angle than the input beam. For a WSS device, it may be necessary to avoid back-reflection to the input. Thus, when the beam steering device 102 is used to attenuate the input beam with a zero-order reflection, a zero-order reflection direction is a direction to which attenuated light is directed. Thus, it may be desired that light from the zero-order reflection is not coupled into any output ports of the WSS device to avoid port crosstalk. In some cases, the zero-order reflection direction may be aligned with the input and, in other cases, the zero-order reflection direction may be offset from the input. In other words, an input direction or angle of the input beam and the common output direction or angle of the combined output beam may be the same or different, based on application.

In some implementations, the beam steering device 102 may reflect the first polarized beam as the first reflected polarized beam on the third optical path 114 toward the second optical component 120. The second optical component 120 may receive the first reflected polarized beam, rotate the first polarization of the first reflected polarized beam into the second polarization, and direct the first reflected polarized beam toward the first optical component 118 with the second polarization. In other words, the second optical component 120 may convert the first polarization of the first reflected polarized beam into the second polarization. Additionally, the beam steering device 102 may reflect the second polarized beam as the second reflected polarized beam on the fourth optical path 116 toward the first optical component 118.

The first optical component 118 may direct the first reflected polarized beam, with the second polarization, toward the output 108 via reflection. Additionally, the first optical component 118 may pass the second reflected polarized beam toward the output 108 with the first polarization. In other words, the first reflected polarized beam and the second reflected polarized beam may have orthogonal polarizations after the first reflected polarized beam interacts with the second optical component 120. The first reflected polarized beam and the second reflected polarized beam may be combined at the output 108 with the orthogonal polarizations, and may be output from the output 108 in the common output direction that depends on the beam steering angle of the beam steering device 102. In some implementations, the first optical component 118 may combine the first reflected polarized beam with the second reflected polarized beam into the combined output beam, and direct the combined output beam at the output 108 in the common output direction. Thus, the optical arrangement 104 may be configured to combine the first reflected polarized beam and the second reflected polarized beam with orthogonal polarizations into the combined output beam, and output the combined output beam at the output 108. A position of the combined output beam relative to the input beam may correspond to an optical pathlength of the optical arrangement 104 and a beam steering angle of the beam steering device. For example, the longer the optical pathlength, the greater the separation between the output 108 and the input 106 in the z-direction.

In some implementations, a sum of the first optical path 110 and the third optical path 114, representing a first total optical path from the input 106 to the output 108, has a first total optical pathlength. Additionally, a sum of the second optical path 112 and the fourth optical path 116, representing a second total optical path from the input 106 to the output 108, has a second total optical pathlength. The optical arrangement 104 may be configured such that the first total optical pathlength and the second total optical pathlength are equal or substantially equal. For example, the first total optical pathlength and the second total optical pathlength may be substantially equal within 1/10 of a bit period for data being transmitted through a WSS device.

The optical arrangement 104 may include a first prism 122 and a second prism 124 that is optically coupled between the first prism 122 and the beam steering device 102. The first prism 122 may include the input 106, the output 108, the first optical component 118, the second optical component 120, and a first reflector 126. The second prism 124 may include a second reflector 128 and a third reflector 130. In this example, the first optical component 118 may be a PBS arranged on the first optical path 110, the second optical path 112, the third optical path 114, and the fourth optical path 116. Additionally, the second optical component 120 may be a quarter-wave retarder with a 45-degree optical axis orientation. The first reflector 126 may be a mirror, a reflective surface, or a reflective film arranged on, coupled to, or integrated with a surface of the first prism 122. Additionally, the second reflector 128 and the third reflector 130 may be mirrors, reflective surfaces, or reflective films arranged on, coupled to, or integrated with a respective surface of the second prism 124.

The input beam with an arbitrary polarization state may be provided at the input 106 of the first prism 122. The first optical component 118 produces the first polarized beam and the second polarized beam with orthogonal linear polarization states. The first polarized beam, with the first polarization, is transmitted through the first optical component 118 and is directed along the first optical path to beam steering device 102 via reflections at the second reflector 128 and the third reflector 130 (e.g., via reflection B1 and reflection B2, respectively). The second polarized beam is reflected by the first optical component 118 (e.g., via reflection A1) toward the second optical component 120. The second polarized beam is transmitted through the second optical component 120, reflected by the first reflector 126 (e.g., via reflection A2) back through the second optical component 120. Thus, the second polarized beam passes through the second optical component 120 twice, resulting in a 90-degree rotation in polarization.

After reflection by the first reflector 126 and a second pass through the second optical component 120, the second polarized beam exhibits a same polarization state as the first polarized beam. The first reflector 126 may be oriented such that the second polarized beam is directed toward the beam steering device 102. Thus, the first polarized beam and the second polarized beam are directed toward the beam steering device 102 such that the first polarized beam and the second polarized beam intersect at a same point-of-incidence on the beam steering device 102 in a manner such that the first polarized beam and the second polarized beam spatially overlap at the beam steering device 102 with a same polarization. In this example, both the first optical path 110 and the second optical path 112 include two reflections.

In some implementations, the first optical component 118 may extend over an entire edge length of a surface of the first prism 122 that is in contact with the second prism 124.

In some implementations, materials used for the first prism 122 and the second prism 124 may be the same, such that the first prism 122 and the second prism 124 have a same refractive index. In some implementations, the first prism 122 may have a higher refractive index than a refractive index of the second prism 124 in order to reduce a size of the first prism 122. For example, a height of the first prism 122 may be reduced by using a lower refractive index than the refractive index of the second prism 124, while maintaining a same optical pathlength for the two polarized beams (e.g., the first optical pathlength travelled by the first polarized beam from the input to the output is equal or substantially equal to the second optical pathlength travelled by the second polarized beam from the input to the output). Thus, the refractive indices may be adjusted to reduce a size of a prism arrangement while maintaining equal or substantially equal optical pathlengths and/or focal distances, as described above. With these conditions, a WSS device with optimized port count, spectral resolution, and PMD can be realized. In some implementations, larger beam sizes and higher port counts may be used, as compared to a WSS device that requires two polarized beams to be spatially separated at a beam steering device.

In some implementations, the optical system 100 is a WSS that includes a plurality of input directions corresponding to a plurality of input ports, respectively, and a plurality of output directions corresponding to a plurality of output ports, respectively. The beam steering device 102 may reflect, with a first zero-order reflection (e.g., a zero-order diffraction), the first polarized beam as the first reflected polarized beam on a third optical path 114 toward the output 108. Additionally, the beam steering device 102 may reflect, with a second zero-order reflection, the second polarized beam as the second reflected polarized beam on the fourth optical path 116 toward the output 108. During zero-order diffractions, the optical arrangement 104 may provide, at the beam steering device 102, an angular offset between the first optical path 110 and the second optical path 112 such that the first reflected polarized beam and the second reflected polarized beam are output in a common output direction that is directed away from all of the plurality of output ports. For example, the common output direction may be directed outside a range of the plurality of output directions. Alternatively, the common output direction may be directed between two adjacent output directions of the plurality of output directions. The reflective sides of the first prism 122 and the second prism 124 may be oriented in a way that defines the angular offset between the first optical path 110 and the second optical path 112.

Additionally, during active beam steering, the beam steering device 102 may reflect, with a first positive first-order reflection (e.g., a positive first-order diffraction), the first polarized beam as the first reflected polarized beam on the third optical path 114 toward the output 108, and reflect, with a second positive first-order reflection, the second polarized beam as the second reflected polarized beam on the fourth optical path 116 toward the output 108. However, unlike during zero-order diffractions, the optical arrangement 104 may provide, at the beam steering device 102, the angular offset between the first optical path 110 and the second optical path 112 such that the first reflected polarized beam and the second reflected polarized beam are output in a common output direction that is directed exclusively at a configured output port selected from the plurality of output ports. In other words, the angular offset may be configured to ensure that the common output direction is not directed at any unintended or undesired output port (e.g., at any unconfigured output port) in order to avoid cross-talk between output ports. The reflective sides of the first prism 122 and the second prism 124 may be oriented in a way that defines the angular offset between the first optical path 110 and the second optical path 112.

Additionally, during the active beam steering, the beam steering device 102 may reflect, with a first negative first-order reflection (e.g., a negative first-order diffraction), the first polarized beam as a third reflected polarized beam on a fifth optical path toward the output 108, and reflect, with a second negative first-order reflection, the second polarized beam as a fourth reflected polarized beam on a sixth optical path toward the output 108. The third reflected polarized beam and the fourth reflected polarized beam may be interference signals generated by negative first-order diffractions. The fifth optical path and the sixth optical path may be different than the third optical path and the fourth optical path. The optical arrangement 104 may provide, at the beam steering device 102, the angular offset between the first optical path and the second optical path such that the third reflected polarized beam and the fourth reflected polarized beam are output in one or more directions that are directed away from all of the plurality of output ports. In other words, the angular offset may be configured to ensure that the third reflected polarized beam and the fourth reflected polarized beam are not directed at any output port, in order to avoid cross-talk between output ports. The reflective sides of the first prism 122 and the second prism 124 may be oriented in a way that defines the angular offset between the first optical path 110 and the second optical path 112.

Additionally, during the active beam steering, the beam steering device 102 may reflect, with a first second-order reflection (e.g., a second-order diffraction), the first polarized beam as a fifth reflected polarized beam on a seventh optical path toward the output 108, and reflect, with a second second-order reflection, the second polarized beam as a sixth reflected polarized beam on an eighth optical path toward the output 108. The fifth reflected polarized beam and the sixth reflected polarized beam may be interference signals generated by second-order diffractions. The seventh optical path and the eighth optical path may be different than the third, fourth, fifth, and sixth optical paths. The optical arrangement 104 may provide, at the beam steering device 102, the angular offset between the first optical path and the second optical path such that the fifth reflected polarized beam and the sixth reflected polarized beam are output in the one or more directions that are directed away from all of the plurality of output ports. In other words, the angular offset may be configured to ensure that the fifth reflected polarized beam and the sixth reflected polarized beam are not directed at any output port, in order to avoid cross-talk between output ports. The reflective sides of the first prism 122 and the second prism 124 may be oriented in a way that defines the angular offset between the first optical path 110 and the second optical path 112.

As indicated above, FIGS. 1A-1D are provided as examples. Other examples may differ from what is described with regard to FIGS. 1A-1D. The number and arrangement of devices and components shown in FIGS. 1A-1D are provided as an example. In practice, there may be additional devices or components, fewer devices or components, different devices or components, or differently arranged devices or components than those shown in FIGS. 1A-1D.

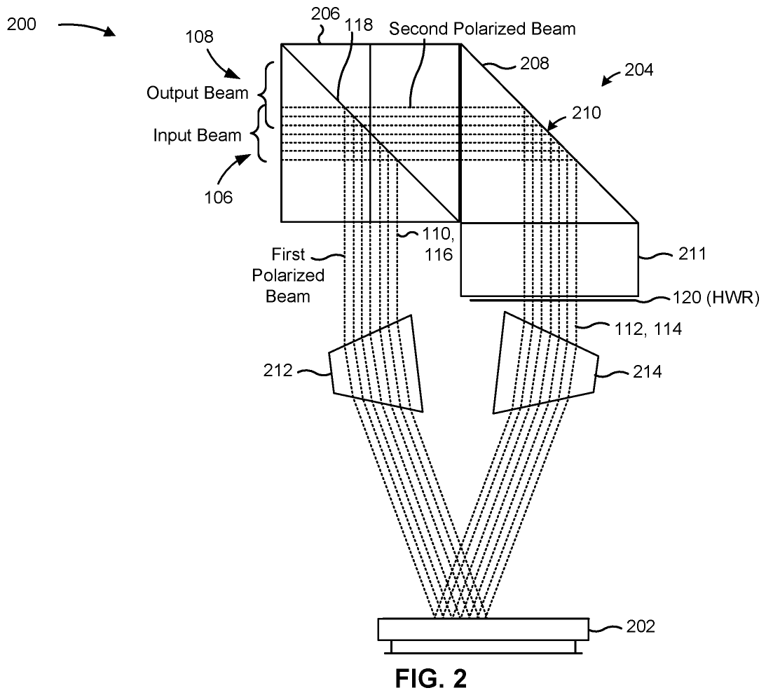

FIG. 2 shows an optical system 200 according to one or more implementations. The optical system 200 may be implemented in a WSS device, for example, for port steering. Similar to the optical system 100 described in connection with FIGS. 1A-1D, the optical system includes a beam steering device 202 and an optical arrangement 204.

The beam steering device 202 may be configured with a beam-steering dependency dependent on a polarization, such as a P-polarization or an S-polarization. The optical arrangement 204 may include a plurality of optical components configured to guide the two polarized light beams along respective optical paths. The optical arrangement 204 may include the input 106, the output 108, the first optical path 110 for the first polarized beam, the second optical path 112 for the second polarized beam, the third optical path 114 for the first polarized beam, and the fourth optical path 116 for the second polarized beam, as similarly described in connection with FIGS. 1A-1D.

In addition, the optical arrangement 204 may generate overlapping polarized beams for beam steering. The optical arrangement 204 may be configured to split an input beam having an arbitrary polarization state into two polarized beams with orthogonal polarizations (e.g., the first polarized beam and the second polarized beam); rotate the first polarized beam to have a same polarization state as the second polarized beam; cause the two polarized beams to intersect at a same area on the beam steering device 202, with an intersection angle in a beam steering direction; have an equal focal distance within a tolerance margin for the two polarized beams; and have a same number of reflections in each beam path of the two polarized beams such that the two polarized beams can be steered by the beam steering device 202 in a same direction. Alternatively, a difference between a number of reflections of the two beam paths may be a multiple of two, such that the two polarized beams can be steered by the beam steering device 302 in a same direction. Moreover, different refractive indices may be used to maintain a same focal distance for the two polarized beams. Thus, by making different parts of the optical system out of materials with different refractive indices, the focal distances for the two polarized beams can be made to be equal or substantially equal. For example, the optical arrangement 204 may focus the first polarized beam onto the beam steering device 202, in the wavelength dispersion direction, within a first depth of focus, and the optical arrangement 204 may focus the second polarized beam onto the beam steering device 202, in the wavelength dispersion direction, within a second depth of focus. As a result, the focal distances for the two polarized beams can be made to be equal within a tolerance margin such that both the first polarized beam and the second polarized beam are in focus at the beam steering device 202. Additionally, the total optical pathlengths, from the input to the output, for the two polarized beams can be made to be equal or substantially equal. For example, the first total optical pathlength and the second total optical pathlength may be substantially equal within 1/10 of a bit period for data being transmitted through a WSS device. A common output direction of the two polarized beams depends on a beam steering angle of the beam steering device 202. Thus, a position of a combined output beam relative to the input beam corresponds to an optical pathlength of the optical arrangement 204 and a beam steering angle of the beam steering device 202. For example, the longer the optical pathlength, the greater the separation between the output 108 and the input 106 in the z-direction.

The optical arrangement 204 may include the first optical component 118 (e.g., a PBS) and the second optical component 120 (e.g., a half-wave retarder). In this example, the first polarized beam is reflected by the first optical component 118 and the second polarized beam is transmitted through the first optical component 118. The second polarized beam may be transmitted through the second optical component 120, and the second optical component 120 may rotate a polarization of the second polarized beam to match a polarization of the first polarized beam. The first optical component and the second optical component are configured such that the first polarized beam and the second polarized beam have a same polarization at the beam steering device 202.

The optical arrangement 204 may include a first prism 206, a second prism 208 with a reflector 210, an optical component 211 made of a high-refractive index material for the purpose of maintaining equal focal distance in the two optical paths, a first redirecting prism 212, and a second redirecting prism 214. The first prism 206 may include the input 106, the output 108, and the first optical component 118 that is arranged on the first optical path 110 and the second optical path 112. The second prism 208 may be arranged on the second optical path 112 and optically coupled between the first prism 206 and the second optical component 120. The reflector 210, arranged on the second optical path 112, may be configured to redirect the second polarized beam further along the second optical path 112 toward the second optical component 120 and the beam steering device 202. The second optical component 120 may be a half-wave retarder (HWR) arranged between the optical component 211 and the second redirecting prism 214, as illustrated, between the first prism 206 and the second prism 208, or between the second prism 208 and the optical component 211. Alternatively, the second optical component 120 may be a half-wave retarder arranged between the first prism 206 and the first redirecting prism 212. Alternatively, the second optical component 120 may be a quarter-wave retarder (QWR) arranged at the reflector 210.

The first redirecting prism 212 may be arranged on the first optical path 110 and optically coupled between the first prism 206 and the beam steering device 202. The first redirecting prism 212 may direct the first polarized beam at the beam steering device 202. The second redirecting prism 214, arranged on the second optical path 112, may be optically coupled between the second prism 208 and the beam steering device 202. The second redirecting prism 214 may direct the second polarized beam, with the same polarization as the first polarized beam, at the beam steering device 202. The optical arrangement 204 may be configured such that the first polarized beam and the second polarized beam spatially overlap at the beam steering device 202 with a same polarization state. The beam steering device 202 may steer the first polarized beam and the second polarized beam toward the output 108 such that the first polarized beam and the second polarized beam are directed from the output 108 in a common output direction.

In some implementations, the beam steering device 202 may be configured to reflect the first polarized beam as the first reflected polarized beam on the third optical path 114 toward the second optical component 120. The second optical component 120 may receive the first reflected polarized beam, rotate the polarization of the first reflected polarized beam 90 degrees, and direct the first reflected polarized beam toward the reflector 210, which may direct the first reflected polarized beam toward the first optical component 118 with a rotated polarization. Additionally, the beam steering device 202 may reflect the second polarized beam as the second reflected polarized beam on the fourth optical path 116 toward the first optical component 118.

The first optical component 118 may direct the second reflected polarized beam toward the output 108 via reflection. Additionally, the first optical component 118 may pass the first reflected polarized beam toward the output 108 with a polarization that is orthogonal to a polarization of the second reflected polarized beam. The first reflected polarized beam and the second reflected polarized beam may be combined at the output 108 with the orthogonal polarizations, and may be output from the output 108 in the common output direction that depends on the beam steering angle of the beam steering device 202. In some implementations, the first optical component 118 may combine the first reflected polarized beam with the second reflected polarized beam into the combined output beam, and direct the combined output beam at the output 108 in the common output direction.

In some implementations, a sum of the first optical path 110 and the third optical path 114, representing a first total optical path from the input 106 to the output 108, has a first total optical pathlength. Additionally, a sum of the second optical path 112 and the fourth optical path 116, representing a second total optical path from the input 106 to the output 108, has a second total optical pathlength. The optical arrangement 204 may be configured such that the first total optical pathlength and the second total optical pathlength are equal or substantially equal.

As indicated above, FIG. 2 is provided as an example. Other examples may differ from what is described with regard to FIG. 2. The number and arrangement of devices and components shown in FIG. 2 are provided as an example. In practice, there may be additional devices or components, fewer devices or components, different devices or components, or differently arranged devices or components than those shown in FIG. 2.

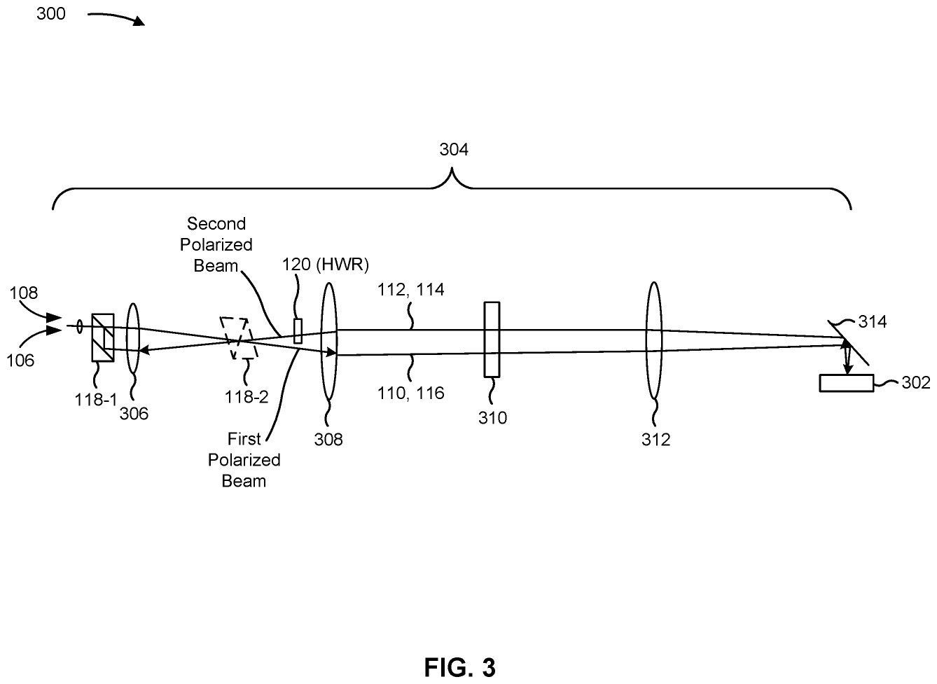

FIG. 3 shows an optical system 300 according to one or more implementations. The optical system 300 may be implemented in a WSS device, for example, for port steering. Similar to the optical system 200 described in connection with FIG. 2, the optical system includes a beam steering device 302 and an optical arrangement 304.

The beam steering device 302 may be configured with a beam-steering dependency dependent on a polarization, such as a P-polarization or an S-polarization. The optical arrangement 304 may include a plurality of optical components configured to guide the two polarized light beams along respective optical paths. The optical arrangement 304 may include the input 106, the output 108, the first optical path 110 for the first polarized beam, the second optical path 112 for the second polarized beam, the third optical path 114 for the first polarized beam, and the fourth optical path 116 for the second polarized beam, as similarly described in connection with FIG. 2.

In addition, the optical arrangement 304 may generate overlapping polarized beams for beam steering. The optical arrangement 304 may be configured to split an input beam having an arbitrary polarization state into two polarized beams with orthogonal polarizations (e.g., the first polarized beam and the second polarized beam); rotate the first polarized beam to have a same polarization state as the second polarized beam; cause the two polarized beams to intersect at a same area on the beam steering device 302, with an intersection angle in a beam steering direction; have an equal focal distance for the two polarized beams; and have a same number of reflections in each beam path of the two polarized beams such that the two polarized beams can be steered by the beam steering device 302 in a same direction. Alternatively, a difference between a number of reflections of the two beam paths may be a multiple of two, such that the two polarized beams can be steered by the beam steering device 302 in a same direction. A common output direction of the two polarized beams depends on a beam steering angle of the beam steering device 302. Thus, a position of a combined output beam relative to the input beam corresponds to a focal length of the switching lens 306 the optical arrangement 304 and a beam steering angle of the beam steering device 302.

The optical arrangement 304 may include a polarized beam splitter 118-1 or a vertical birefringent wedge 118-2 as the first optical component 118 that produces two polarized beams from the input beam. Additionally, the optical arrangement 304 may include the second optical component 120 (e.g., an HWR). Additionally, the optical arrangement 304 may include a switching lens 306, an optical element 308 (e.g., a lens that may collimate light in a first direction and focus light in an opposite, second direction), a grating-dispersion element 310 to separate wavelengths, an optical element 312 (e.g., a lens that may focus light in the first direction and collimate light in the opposite, second direction), and a reflector 314. The beam steering device 302 may be located at a focal point of the optical element 312. The switching lens 306 may convert an angle of an output beam to a corresponding port of a WSS device.

The optical system 300 may operate in a similar manner to an operation of the optical system 200 described in connection with FIG. 2. Thus, the optical arrangement 304 may be configured such that the first polarized beam and the second polarized beam spatially overlap at the beam steering device 302 with a same polarization state. The beam steering device 302 may steer the first polarized beam and the second polarized beam toward the output 108 such that the first polarized beam and the second polarized beam are directed from the output 108 in a common output direction.

As indicated above, FIG. 3 is provided as an example. Other examples may differ from what is described with regard to FIG. 3. The number and arrangement of devices and components shown in FIG. 3 are provided as an example. In practice, there may be additional devices or components, fewer devices or components, different devices or components, or differently arranged devices or components than those shown in FIG. 3.

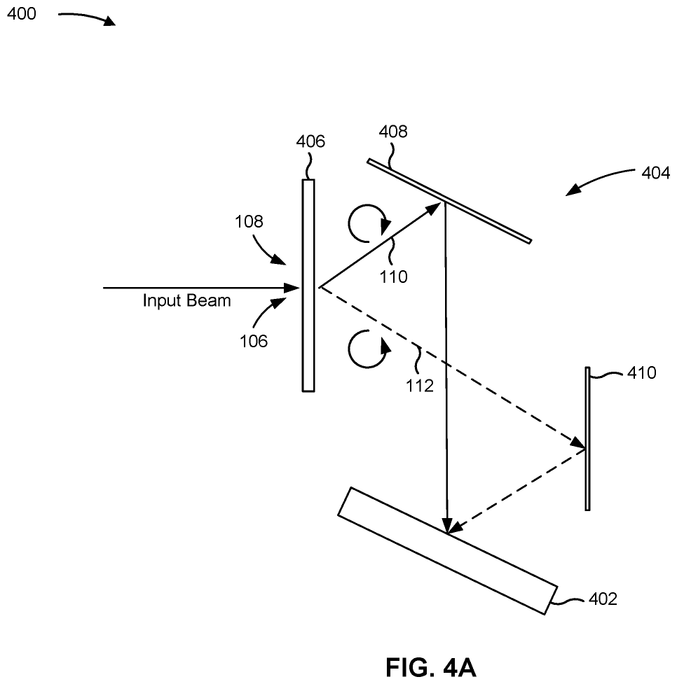

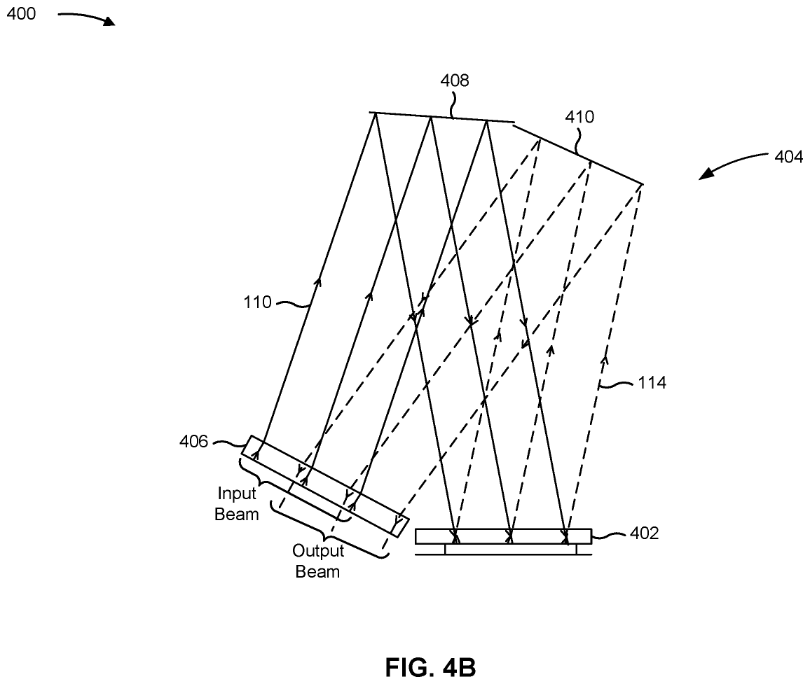

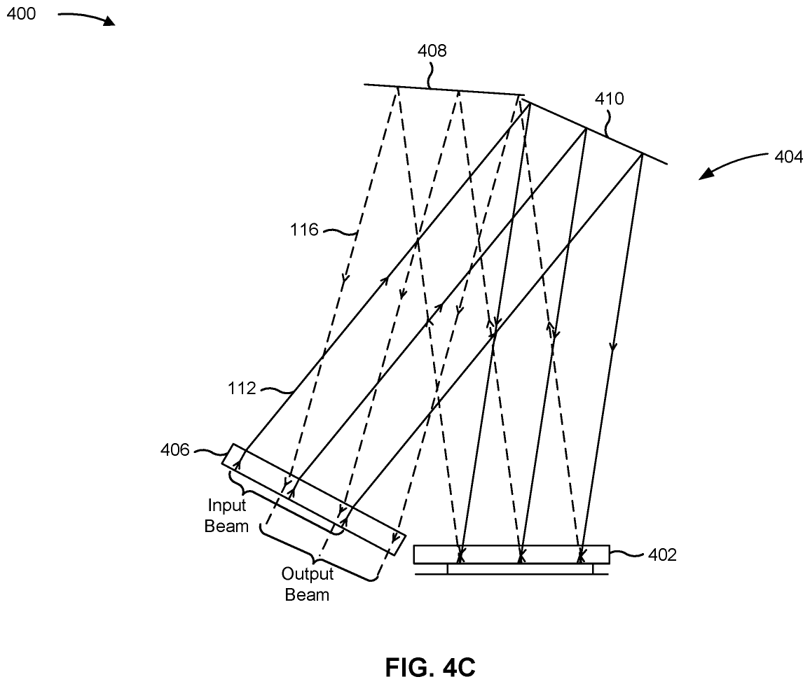

FIGS. 4A-4C show an optical system 400 according to one or more implementations. The optical system 400 may be implemented in a WSS device, for example, for port steering. The optical system 400 may include a beam steering device 402 and an optical arrangement 404.

The beam steering device 402 may be configured with a beam-steering dependency dependent on a linear polarization. For example, the beam steering device 402 may be configured to steer only light having the linear polarization. In some implementations, the beam steering device 402 may be a polarization-dependent LCOS array, a polarization-dependent spatial light modulator, or a polarization-dependent light director array. The beam steering device 402 may be configured to steer two polarized light beams to a common output direction. However, in order to simultaneously steer the two polarized light beams, the two polarized light beams incident on the beam steering device 402 must a same polarization orientation as the polarization in which the beam steering device 402 operates. Thus, if the beam steering device 402 is configured to steer light having a particular linear polarization, the two polarized light beams must have the particular linear polarization.

The optical arrangement 404 may include an input 106 (e.g., an optical input), an output 108 (e.g., an optical output), a first optical path 110 for a first polarized beam, a second optical path 112 for a second polarized beam, a third optical path 114 for the first polarized beam, and a fourth optical path 116 for the second polarized beam. FIG. 4A shows a trajectory of the first polarized beam and the second polarized beam, with corresponding polarizations. FIG. 4B shows a trajectory of the first polarized beam and the first reflected polarized beam with actual beam widths. FIG. 4C shows a trajectory of the second polarized beam and the second reflected polarized beam with actual beam widths. The first polarized beam and the second polarized beam substantially, if not fully, overlap at the beam steering device 402. The first reflected polarized beam is produced by reflection of the first polarized beam at the beam steering device 402. The second reflected polarized beam is produced by reflection of the second polarized beam at the beam steering device 402.

The input 106 may receive an input beam with an arbitrary polarization state (e.g., an unpolarized state). The first optical path 110 and the second optical path 112 may extend from the input 106 and intersect at a same point-of-incidence on the beam steering device 402. The third optical path 114 and the fourth optical path 116 may extend from the beam steering device 402 to the output 108, for example, after reflection at the beam steering device 402.

The optical arrangement 404 may include a polarization grating 406, a first mirror 408 including a first retarder, and a second mirror 410 including a second retarder. The polarization grating 406 may be arranged at the input 106 and the output 108. Additionally, the polarization grating 406 may split the input beam into two orthogonally polarized beams including a first polarized beam having a left circular polarization (e.g., a counter-clockwise polarization) and a second polarized beam having a right circular polarization (e.g., a clockwise polarization). The polarization grating 406 may direct the first polarized beam along the first optical path 110 with the left circular polarization, and direct the second polarized beam along the second optical path 112 with the right circular polarization.

The first mirror 408 may be arranged on the first optical path 110 between the polarization grating 406 and the beam steering device 402. The first retarder of the first mirror 408 may convert the left circular polarization of the first polarized beam into the linear polarization, and the first mirror 408 may direct the first polarized beam further along the first optical path 110 with the linear polarization.

The second mirror 410 may be arranged on the second optical path 112 between the polarization grating 406 and the beam steering device 402. The second retarder of the second mirror 410 may convert the right circular polarization of the second polarized beam into the linear polarization, and the second mirror 410 may direct the second polarized beam further along the second optical path 112 with the linear polarization.

The first polarization beam and the second polarization beam, with a same linear polarization, spatially overlap at the beam steering device 402. In particular, the first polarization beam and the second polarization beam may at least partially spatially overlap at a target area of the beam steering device 402. For example, at least 90% of a first area of the beam steering device 402 at which the first polarized beam is incident on the beam steering device 102 spatially overlaps with a second area of the beam steering device 402 at which the second polarized beam is incident on the beam steering device. In some implementations, the first mirror 408 and the second mirror 410 may be configured such that the first polarized beam, with the linear polarization, and the second polarized beam, with the linear polarization, completely spatially overlap at the beam steering device 402. The first polarized beam and the second polarized beam may fill or substantially fill an aperture of the beam steering device 402.

The beam steering device 402 may steer the first polarized beam and the second polarized beam toward the output 108 such that the first polarized beam and the second polarized beam are directed from the output 108 in the common output direction, as similarly described above with respect to the optical systems 100, 200, and 300.

Moreover, a first optical pathlength travelled by the first polarized beam from the input 106 to the output 108 may be equal or substantially equal to a second optical pathlength travelled by the second polarized beam from the input 106 to the output 108.

The optical arrangement 404 may be configured such that the first optical path 110 has a first number of reflections, and the second optical path 112 has a second number of reflections that is equal to the first number of reflections. Alternatively, a difference between the first number of reflections and the second number of reflections may be a multiple of two.

In addition, the first mirror 408 and the second mirror 410 may be configured such that the first polarized beam, with the linear polarization, and the second polarized beam, with the linear polarization, intersect at the same point-of-incidence with an intersection angle in a beam steering direction of the beam steering device 402.

As indicated above, FIGS. 4A-4C are provided as examples. Other examples may differ from what is described with regard to FIGS. 4A-4C. The number and arrangement of devices and components shown in FIGS. 4A-4C are provided as an example. In practice, there may be additional devices or components, fewer devices or components, different devices or components, or differently arranged devices or components than those shown in FIGS. 4A-4C.

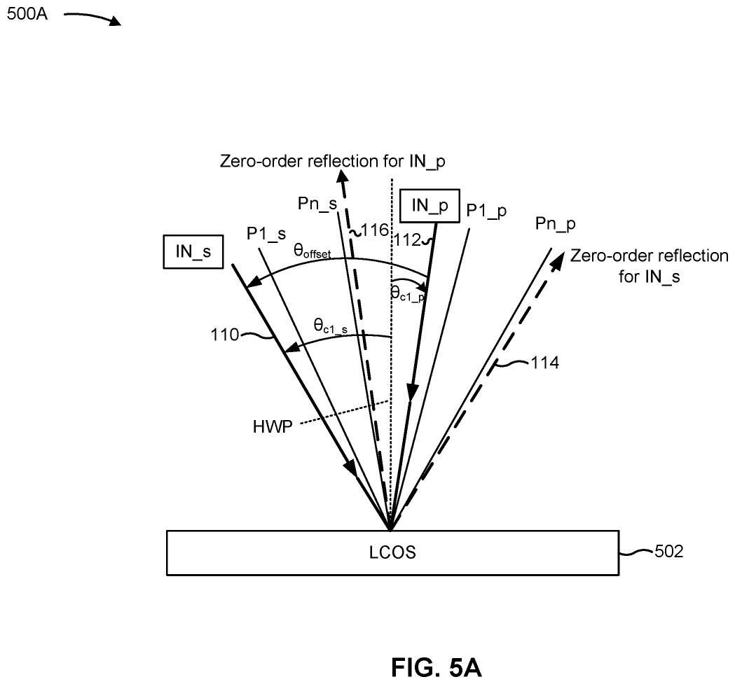

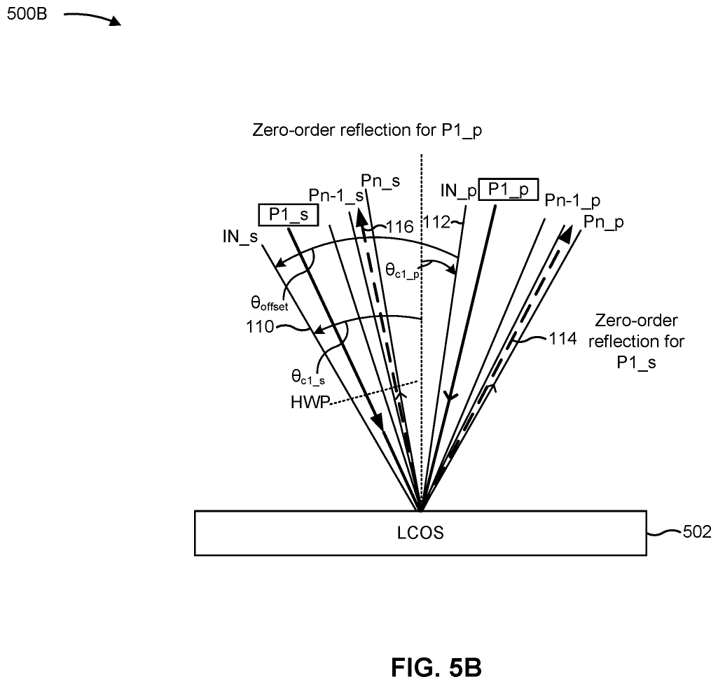

FIGS. 5A and 5B show input/output direction arrangements 500A and 500B according to one or more implementations. The input/output direction arrangements 500A and 500B may correspond to an input/output direction arrangement of one of the optical systems 100, 200, 300, or 400. The input/output direction arrangements 500A and 500B show reflections at a beam steering device 502 (e.g., an LCOS) during a zero-order reflection. The input/output direction arrangements 500A and 500B include a plurality of input directions corresponding to one or more input ports, respectively, and a plurality of output directions corresponding to a plurality of output ports, respectively. For example, IN_s and IN_p may correspond to the first optical path 110 and the second optical path 112, respectively, which may correspond to an input direction from a first input port. P1_s and P1_p may correspond to reflection paths that may correspond to an output direction of a first output port. Additionally, Pn-1_s and Pn-1_p may correspond to reflection paths that may correspond to an output direction of a second output port. Additionally, Pn_s and Pn_p may correspond to reflection paths that may correspond to an output direction of a third output port.

The first optical path 110 may have a first angle of incidence θ_{c1_p} relative to the beam steering device 502 and the second optical path 112 may have a second angle of incidence θ_{c1_s} relative to the beam steering device 502. The sum of the first angle of incidence θ_{c1_p} and the second angle of incidence θ_{c1_s} equals an angular offset θ_{offset}. The beam steering device 502 may reflect, with a first zero-order reflection (e.g., a zero-order diffraction), the first polarized beam as the first reflected polarized beam on the third optical path 114 toward the output 108. Additionally, the beam steering device 502 may reflect, with a second zero-order reflection, the second polarized beam as the second reflected polarized beam on the fourth optical path 116 toward the output 108. During zero-order diffractions, the optical arrangement of the optical system may provide, at the beam steering device 102, the angular offset θ_{offset} between the first optical path 110 and the second optical path 112 such that the first reflected polarized beam and the second reflected polarized beam are output in a common output direction from the optical system that is directed away from all of the plurality of output ports. For example, the common output direction may be directed outside of a range of the plurality of output directions, as shown in FIG. 5A. Alternatively, the common output direction may be directed between two adjacent output directions of the plurality of output directions, as shown in FIG. 5B.

As indicated above, FIGS. 5A and 5B are provided as examples. Other examples may differ from what is described with regard to FIGS. 5A and 5B.

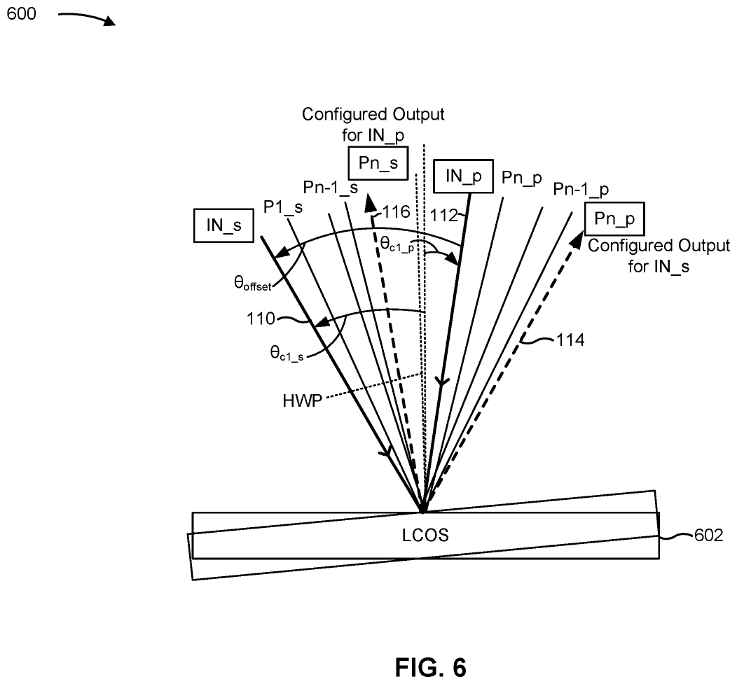

FIG. 6 shows an input/output direction arrangement 600 according to one or more implementations. The input/output direction arrangement 600 may correspond to an input/output direction arrangement of one of the optical systems 100, 200, 300, or 400. The input/output direction arrangement 600 shows reflections at a beam steering device 602 (e.g., an LCOS) during a zero-order reflection. The input/output direction arrangement 600 includes a plurality of input directions corresponding to one or more input ports, respectively, and a plurality of output directions corresponding to a plurality of output ports, respectively. In this example, active beam steering is performed by the beam steering device 602 to direct positive first-order reflections at a configured output port. Thus, an input port is linked, paired, or otherwise configured with the configured output port. Thus, the first optical path 110 and the second optical path 112 are linked with the configured output port via the third optical path 114 and the fourth optical path 116, respectively.

During active beam steering, the beam steering device 602 may reflect, with a first positive first-order reflection (e.g., a positive first-order diffraction), the first polarized beam as the first reflected polarized beam on the third optical path 114 toward the output 108, and reflect, with a second positive first-order reflection, the second polarized beam as the second reflected polarized beam on the fourth optical path 116 toward the output 108. However, unlike during zero-order diffractions, the optical arrangement of the optical system may provide, at the beam steering device 602, an angular offset θ_{offset} between the first optical path 110 and the second optical path 112 such that the first reflected polarized beam and the second reflected polarized beam are output from the optical system in a common output direction that is directed exclusively at the configured output port selected from the plurality of output ports. In other words, the angular offset θ_{offset} may be configured to ensure that the common output direction is not directed at any unintended or undesired output port (e.g., at any unconfigured output port) in order to avoid cross-talk between output ports.

Additionally, during the active beam steering, the beam steering device 602 may reflect, with a first negative first-order reflection (e.g., a negative first-order diffraction), the first polarized beam as a third reflected polarized beam on a fifth optical path toward the output 108, and reflect, with a second negative first-order reflection, the second polarized beam as a fourth reflected polarized beam on a sixth optical path toward the output 108. The third reflected polarized beam and the fourth reflected polarized beam may be interference signals generated by negative first-order diffractions. The fifth optical path and the sixth optical path may be different than the third optical path 114 and the fourth optical path 116. The optical arrangement of the optical system may provide, at the beam steering device 602, the angular offset θ_{offset} between the first optical path and the second optical path such that the third reflected polarized beam and the fourth reflected polarized beam are output in one or more directions that are directed away from all of the plurality of output ports. In other words, the angular offset θ_{offset} may be configured to ensure that the third reflected polarized beam and the fourth reflected polarized beam are not directed at any output port, in order to avoid cross-talk between output ports. The reflective sides of the first prism 122 and the second prism 124 may be oriented in a way that defines the angular offset θ_{offset} between the first optical path 110 and the second optical path 112.

Additionally, during the active beam steering, the beam steering device 602 may reflect, with a first second-order reflection (e.g., a second-order diffraction), the first polarized beam as a fifth reflected polarized beam on a seventh optical path toward the output 108, and reflect, with a second second-order reflection, the second polarized beam as a sixth reflected polarized beam on an eighth optical path toward the output 108. The fifth reflected polarized beam and the sixth reflected polarized beam may be interference signals generated by second-order diffractions. The seventh optical path and the eighth optical path may be different than the third, fourth, fifth, and sixth optical paths. The optical arrangement of the optical system may provide, at the beam steering device 602, the angular offset θ_{offset} between the first optical path and the second optical path such that the fifth reflected polarized beam and the sixth reflected polarized beam are output in the one or more directions that are directed away from all of the plurality of output ports. In other words, the angular offset θ_{offset} may be configured to ensure that the fifth reflected polarized beam and the sixth reflected polarized beam are not directed at any output port, in order to avoid cross-talk between output ports. The reflective sides of the first prism 122 and the second prism 124 may be oriented in a way that defines the angular offset θ_{offset} between the first optical path 110 and the second optical path 112.

As indicated above, FIG. 6 is provided as an example. Other examples may differ from what is described with regard to FIG. 6.

The following provides an overview of some Aspects of the present disclosure:

Aspect 1: An optical system, comprising: a beam steering device configured with a beam-steering dependency dependent on a first polarization, wherein the beam steering device is configured to steer only light having the first polarization; and an optical arrangement comprising an input, a first optical path, and a second optical path, and an output, wherein the input is configured to receive an input beam with an arbitrary polarization state, and wherein the first optical path and the second optical path extend from the input and intersect at a same point-of-incidence on the beam steering device, wherein the optical arrangement further comprises: a first optical component configured to split the input beam into two orthogonally polarized beams including a first polarized beam and a second polarized beam, wherein the first optical component is configured to direct the first polarized beam along the first optical path with the first polarization, and direct the second polarized beam along the second optical path with a second polarization that is orthogonal to the first polarization; and a second optical component configured to receive the second polarized beam, rotate the second polarization of the second polarized beam into the first polarization, and direct the second polarized beam further along the second optical path with the first polarization, wherein the first optical component and the second optical component are configured such that the first polarized beam, with the first polarization, and the second polarized beam, with the first polarization, spatially overlap at the beam steering device, and wherein the beam steering device is configured to steer the first polarized beam and the second polarized beam toward the output such that the first polarized beam and the second polarized beam are directed from the output in a common output direction.

Aspect 2: The optical system of Aspect 1, wherein the first optical component and the second optical component are configured such that the first polarized beam, with the first polarization, and the second polarized beam, with the first polarization, spatially overlap at the beam steering device, wherein at least 90% of a first area of the beam steering device at which the first polarized beam is incident on the beam steering device spatially overlaps with a second area of the beam steering device at which the second polarized beam is incident on the beam steering device.

Aspect 3: The optical system of any of Aspects 1-2, wherein the first optical component and the second optical component are configured such that the first polarized beam, with the first polarization, and the second polarized beam, with the first polarization, completely spatially overlap at the beam steering device.

Aspect 4: The optical system of any of Aspects 1-3, wherein the first optical component and the second optical component are configured such that the first polarized beam, with the first polarization, and the second polarized beam, with the first polarization, intersect at the same point-of-incidence with an intersection angle in a beam steering direction of the beam steering device.

Aspect 5: The optical system of any of Aspects 1-4, wherein the optical arrangement is configured to focus the first polarized beam onto the beam steering device, in a wavelength dispersion direction, within a first depth of focus, and wherein the optical arrangement is configured to focus the second polarized beam onto the beam steering device, in the wavelength dispersion direction, within a second depth of focus.

Aspect 6: The optical system of any of Aspects 1-5, wherein a first optical pathlength travelled by the first polarized beam from the input to the output is equal to a second optical pathlength travelled by the second polarized beam from the input to the output.

Aspect 7: The optical system of any of Aspects 1-6, wherein the optical arrangement is configured such that the first optical path has a first number of reflections, and the second optical path has a second number of reflections that is equal to the first number of reflections or a difference between the first number of reflections and the second number of reflections is a multiple of two.

Aspect 8: The optical system of any of Aspects 1-7, wherein the beam steering device is configured to reflect the first polarized beam such that the first polarized beam retraces the second optical path, and wherein the beam steering device is configured to reflect the second polarized beam such that the second polarized beam retraces the first optical path.

Aspect 9: The optical system of any of Aspects 1-8, wherein the beam steering device is configured to reflect the first polarized beam as a first reflected polarized beam on a third optical path toward the second optical component, wherein the second optical component is configured to receive the first reflected polarized beam, rotate the first polarization of the first reflected polarized beam into the second polarization, and direct the first reflected polarized beam toward the first optical component with the second polarization, and wherein the first optical component is configured to direct the first reflected polarized beam toward the output with the second polarization.

Aspect 10: The optical system of Aspect 9, wherein the beam steering device is configured to reflect the second polarized beam as a second reflected polarized beam on a fourth optical path toward the first optical component, and wherein the first optical component is configured to direct the second reflected polarized beam toward the output with the first polarization.

Aspect 11: The optical system of Aspect 10, wherein a sum of the first optical path and the third optical path, representing a first total optical path from the input to the output, has a first total optical pathlength, wherein a sum of the second optical path and the fourth optical path, representing a second total optical path from the input to the output, has a second total optical pathlength, and wherein the first total optical pathlength and the second total optical pathlength are equal.

Aspect 12: The optical system of Aspect 10, wherein the first optical component is configured to combine the first reflected polarized beam with the second reflected polarized beam into a combined output beam, and direct the combined output beam at the output in the common output direction.

Aspect 13: The optical system of any of Aspects 1-12, wherein the common output direction depends on a beam steering angle of the beam steering device.

Aspect 14: The optical system of any of Aspects 1-13, wherein the beam steering device is configured to reflect the first polarized beam as a first reflected polarized beam on a third optical path toward the output, wherein the beam steering device is configured to reflect the second polarized beam as a second reflected polarized beam on a fourth optical path toward the output, wherein the optical arrangement is configured to combine the first reflected polarized beam and the second reflected polarized beam with orthogonal polarizations into a combined output beam, and output the combined output beam at the output, and wherein a position of the combined output beam relative to the input beam corresponds to an optical path pathlength of the optical arrangement and a beam steering angle of the beam steering device.

Aspect 15: The optical system of any of Aspects 1-14, wherein the optical system is a WSS, and the beam steering device is configured to steer the light in a port switching direction of the WSS, wherein the port switching direction is perpendicular to a wavelength dispersion direction of the WSS.

Aspect 16: The optical system of Aspect 15, wherein the WSS is configured to collimate the first polarized beam and the second polarized beam in the port switching direction and focus the first polarized beam and the second polarized beam in the wavelength dispersion direction.

Aspect 17: The optical system of any of Aspects 1-16, wherein the beam steering device is a liquid-crystal-on-silicon (LCOS) array.

Aspect 18: The optical system of any of Aspects 1-17, wherein the first polarization and the second polarization are linear polarizations.

Aspect 19: The optical system of any of Aspects 1-18, wherein the optical arrangement includes: a first prism comprising the input, the output, the first optical component, the second optical component, and a reflector, wherein the first optical component is a polarization beam splitter arranged on the first optical path and the second optical path, wherein the second optical component is a quarter-wave retarder, wherein the first optical component, the second optical component, and the reflector are arranged on the second optical path; and a second prism optically coupled between the first prism and the beam steering device.

Aspect 20: The optical system of any of Aspects 1-19, wherein the optical arrangement includes: a first prism comprising the input, the output, and the first optical component, wherein the first optical component is a polarization beam splitter arranged on the first optical path and the second optical path; a second prism arranged on the second optical path and optically coupled between the first prism and the second optical component; a first redirecting prism arranged on the first optical path and optically coupled between the first prism and the beam steering device, wherein the first redirecting prism is configured to direct the first polarized beam, with the first polarization, at the beam steering device; and a second redirecting prism arranged on the second optical path and optically coupled between the second prism and the beam steering device, wherein the second redirecting prism is configured to direct the second polarized beam, with the first polarization, at the beam steering device, wherein the second optical component is a half-wave retarder.

Aspect 21: The optical system of any of Aspects 1-20, wherein the optical system is a WSS comprising a plurality of input directions corresponding to one or more input ports, respectively, and a plurality of output directions corresponding to a plurality of output ports, respectively, wherein the beam steering device is configured to reflect, with a first zero-order reflection, the first polarized beam as a first reflected polarized beam on a third optical path toward the output, wherein the beam steering device is configured to reflect, with a second zero-order reflection, the second polarized beam as a second reflected polarized beam on a fourth optical path toward the output, and wherein the optical arrangement is configured to provide, at the beam steering device, an angular offset between the first optical path and the second optical path such that the first reflected polarized beam and the second reflected polarized beam are output in the common output direction that is directed away from all of the plurality of output ports.

Aspect 22: The optical system of Aspect 21, wherein the common output direction is outside a range of the plurality of output directions.

Aspect 23: The optical system of Aspect 21, wherein the common output direction is between two adjacent output directions of the plurality of output directions.

Aspect 24: The optical system of any of Aspects 1-23, wherein the optical system is a WSS comprising a plurality of input directions corresponding to one or more input ports, respectively, and a plurality of output directions corresponding to a plurality of output ports, respectively, wherein the beam steering device is configured to reflect, with a first positive first-order reflection, the first polarized beam as a first reflected polarized beam on a third optical path toward the output, wherein the beam steering device is configured to reflect, with a second positive first-order reflection, the second polarized beam as a second reflected polarized beam on a fourth optical path toward the output, and wherein the optical arrangement is configured to provide, at the beam steering device, an angular offset between the first optical path and the second optical path such that the first reflected polarized beam and the second reflected polarized beam are output in the common output direction that is directed exclusively at a configured output port selected from the plurality of output ports.

Aspect 25: The optical system of Aspect 24, wherein the beam steering device is configured to reflect, with a first negative first-order reflection, the first polarized beam as a third reflected polarized beam on a fifth optical path toward the output, wherein the beam steering device is configured to reflect, with a second negative first-order reflection, the second polarized beam as a fourth reflected polarized beam on a sixth optical path toward the output, and wherein the optical arrangement is configured to provide, at the beam steering device, the angular offset between the first optical path and the second optical path such that the third reflected polarized beam and the fourth reflected polarized beam are output in one or more directions that are directed away from all of the plurality of output ports.

Aspect 26: The optical system of Aspect 24, wherein the beam steering device is configured to reflect, with a first second-order reflection, the first polarized beam as a third reflected polarized beam on a fifth optical path toward the output, wherein the beam steering device is configured to reflect, with a second second-order reflection, the second polarized beam as a fourth reflected polarized beam on a sixth optical path toward the output, and wherein the optical arrangement is configured to provide, at the beam steering device, the angular offset between the first optical path and the second optical path such that the third reflected polarized beam and the fourth reflected polarized beam are output in the one or more directions that are directed away from all of the plurality of output ports.

Aspect 27: An optical system, comprising: a beam steering device configured with a beam-steering dependency dependent on a linear polarization, wherein the beam steering device is configured to steer only light having the linear polarization; and an optical arrangement comprising an input, a first optical path, and a second optical path, and an output, wherein the input is configured to receive an input beam with an arbitrary polarization state, and wherein the first optical path and the second optical path extend from the input and intersect at a same point-of-incidence on the beam steering device, wherein the optical arrangement further comprises: a polarization grating arranged at the input and the output, wherein the polarization grating is configured to split the input beam into two orthogonally polarized beams including a first polarized beam having a left circular polarization and a second polarized beam having a right circular polarization, a first mirror comprising a first retarder, wherein the first mirror is arranged on the first optical path between the polarization grating and the beam steering device, wherein the first mirror is configured to convert the left circular polarization of the first polarized beam into the linear polarization, and direct the first polarized beam further along the first optical path with the linear polarization; and a second mirror comprising a second retarder, wherein the second mirror is arranged on the second optical path between the polarization grating and the beam steering device, wherein the second mirror is configured to convert the right circular polarization of the second polarized beam into the linear polarization, and direct the second polarized beam further along the second optical path with the linear polarization.

Aspect 28: The optical system of Aspect 27, wherein a first optical pathlength travelled by the first polarized beam from the input to the output is equal to a second optical pathlength travelled by the second polarized beam from the input to the output.

Aspect 29: The optical system of any of Aspects 27-28, wherein the optical arrangement is configured such that the first optical path has a first number of reflections, and the second optical path has a second number of reflections that is equal to the first number of reflections or a difference between the first number of reflections and the second number of reflections is a multiple of two.

Aspect 30: The optical system of any of Aspects 27-29, wherein the first mirror and the second mirror are configured such that the first polarized beam, with the linear polarization, and the second polarized beam, with the linear polarization, intersect at the same point-of-incidence with an intersection angle in a beam steering direction of the beam steering device.

Aspect 31: A system configured to perform one or more operations recited in one or more of Aspects 1-30.

Aspect 32: An apparatus comprising means for performing one or more operations recited in one or more of Aspects 1-30.

Aspect 33: A non-transitory computer-readable medium storing a set of instructions, the set of instructions comprising one or more instructions that, when executed by a device, cause the device to perform one or more operations recited in one or more of Aspects 1-30.

Aspect 34: A computer program product comprising instructions or code for executing one or more operations recited in one or more of Aspects 1-30.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
a beam steering device configured with a beam-steering dependency dependent on a first polarization, wherein the beam steering device is configured to steer only light having the first polarization; and
an optical arrangement comprising an input, a first optical path, and a second optical path, and an output, wherein the input is configured to receive an input beam with an arbitrary polarization state, and wherein the first optical path and the second optical path extend from the input and intersect at a same point-of-incidence on the beam steering device,
wherein the optical arrangement further comprises:
a first optical component configured to split the input beam into two orthogonally polarized beams including a first polarized beam and a second polarized beam, wherein the first optical component is configured to direct the first polarized beam along the first optical path with the first polarization, and direct the second polarized beam along the second optical path with a second polarization that is orthogonal to the first polarization; and
a second optical component configured to receive the second polarized beam, rotate the second polarization of the second polarized beam into the first polarization, and direct the second polarized beam further along the second optical path with the first polarization,
wherein the first optical component and the second optical component are configured such that the first polarized beam, with the first polarization, and the second polarized beam, with the first polarization, spatially overlap at the beam steering device, and
wherein the beam steering device is configured to steer the first polarized beam and the second polarized beam toward the output such that the first polarized beam and the second polarized beam are directed from the output in a common output direction.

2. The optical system of claim 1, wherein the first optical component and the second optical component are configured such that the first polarized beam, with the first polarization, and the second polarized beam, with the first polarization, spatially overlap at the beam steering device,
wherein at least 90% of a first area of the beam steering device at which the first polarized beam is incident on the beam steering device spatially overlaps with a second area of the beam steering device at which the second polarized beam is incident on the beam steering device.

3. The optical system of claim 1, wherein the first optical component and the second optical component are configured such that the first polarized beam, with the first polarization, and the second polarized beam, with the first polarization, completely spatially overlap at the beam steering device.

4. The optical system of claim 1, wherein the first optical component and the second optical component are configured such that the first polarized beam, with the first polarization, and the second polarized beam, with the first polarization, intersect at the same point-of-incidence with an intersection angle in a beam steering direction of the beam steering device.

5. The optical system of claim 1, wherein the optical arrangement is configured to focus the first polarized beam onto the beam steering device, in a wavelength dispersion direction, within a first depth of focus, and
wherein the optical arrangement is configured to focus the second polarized beam onto the beam steering device, in the wavelength dispersion direction, within a second depth of focus.

6. The optical system of claim 1, wherein a first optical pathlength travelled by the first polarized beam from the input to the output is equal to a second optical pathlength travelled by the second polarized beam from the input to the output.

7. The optical system of claim 1, wherein the optical arrangement is configured such that the first optical path has a first number of reflections, and the second optical path has a second number of reflections that is equal to the first number of reflections or a difference between the first number of reflections and the second number of reflections is a multiple of two.

8. The optical system of claim 1, wherein the beam steering device is configured to reflect the first polarized beam such that the first polarized beam retraces the second optical path, and
wherein the beam steering device is configured to reflect the second polarized beam such that the second polarized beam retraces the first optical path.

9. The optical system of claim 1, wherein the beam steering device is configured to reflect the first polarized beam as a first reflected polarized beam on a third optical path toward the second optical component,
wherein the second optical component is configured to receive the first reflected polarized beam, rotate the first polarization of the first reflected polarized beam into the second polarization, and direct the first reflected polarized beam toward the first optical component with the second polarization, and
wherein the first optical component is configured to direct the first reflected polarized beam toward the output with the second polarization.

10. The optical system of claim 9, wherein the beam steering device is configured to reflect the second polarized beam as a second reflected polarized beam on a fourth optical path toward the first optical component, and
wherein the first optical component is configured to direct the second reflected polarized beam toward the output with the first polarization.

11. The optical system of claim 10, wherein a sum of the first optical path and the third optical path, representing a first total optical path from the input to the output, has a first total optical pathlength,
wherein a sum of the second optical path and the fourth optical path, representing a second total optical path from the input to the output, has a second total optical pathlength, and
wherein the first total optical pathlength and the second total optical pathlength are substantially equal.

12. The optical system of claim 10, wherein the first optical component is configured to combine the first reflected polarized beam with the second reflected polarized beam into a combined output beam, and direct the combined output beam at the output in the common output direction.

13. The optical system of claim 1, wherein the common output direction depends on a beam steering angle of the beam steering device.

14. The optical system of claim 1, wherein the beam steering device is configured to reflect the first polarized beam as a first reflected polarized beam on a third optical path toward the output,
wherein the beam steering device is configured to reflect the second polarized beam as a second reflected polarized beam on a fourth optical path toward the output,
wherein the optical arrangement is configured to combine the first reflected polarized beam and the second reflected polarized beam with orthogonal polarizations into a combined output beam, and output the combined output beam at the output, and
wherein a position of the combined output beam relative to the input beam corresponds to an optical path pathlength of the optical arrangement and a beam steering angle of the beam steering device.

15. The optical system of claim 1, wherein the optical system is a wavelength selective switch (WSS), and the beam steering device is configured to steer the light in a port switching direction of the WSS, wherein the port switching direction is perpendicular to a wavelength dispersion direction of the WSS.

16. The optical system of claim 15, wherein the WSS is configured to collimate the first polarized beam and the second polarized beam in the port switching direction and focus the first polarized beam and the second polarized beam in the wavelength dispersion direction.

17. The optical system of claim 1, wherein the beam steering device is a liquid-crystal-on-silicon (LCOS) array.

18. The optical system of claim 1, wherein the first polarization and the second polarization are linear polarizations.

19. The optical system of claim 1, wherein the optical arrangement includes:
a first prism comprising the input, the output, the first optical component, the second optical component, and a reflector,
wherein the first optical component is a polarization beam splitter arranged on the first optical path and the second optical path,
wherein the second optical component is a quarter-wave retarder,
wherein the first optical component, the second optical component, and the reflector are arranged on the second optical path; and
a second prism optically coupled between the first prism and the beam steering device.

20. The optical system of claim 1, wherein the optical arrangement includes:
a first prism comprising the input, the output, and the first optical component, wherein the first optical component is a polarization beam splitter arranged on the first optical path and the second optical path;
a second prism arranged on the second optical path and optically coupled between the first prism and the second optical component;
a first redirecting prism arranged on the first optical path and optically coupled between the first prism and the beam steering device, wherein the first redirecting prism is configured to direct the first polarized beam, with the first polarization, at the beam steering device; and
a second redirecting prism arranged on the second optical path and optically coupled between the second prism and the beam steering device, wherein the second redirecting prism is configured to direct the second polarized beam, with the first polarization, at the beam steering device,
wherein the second optical component is a half-wave retarder.

21. The optical system of claim 1, wherein the optical system is a wavelength selective switch (WSS) comprising a plurality of input directions corresponding to one or more input ports, respectively, and a plurality of output directions corresponding to a plurality of output ports, respectively,
wherein the beam steering device is configured to reflect, with a first zero-order reflection, the first polarized beam as a first reflected polarized beam on a third optical path toward the output,
wherein the beam steering device is configured to reflect, with a second zero-order reflection, the second polarized beam as a second reflected polarized beam on a fourth optical path toward the output, and
wherein the optical arrangement is configured to provide, at the beam steering device, an angular offset between the first optical path and the second optical path such that the first reflected polarized beam and the second reflected polarized beam are output in the common output direction that is directed away from all of the plurality of output ports.

22. The optical system of claim 21, wherein the common output direction is outside a range of the plurality of output directions.

23. The optical system of claim 21, wherein the common output direction is between two adjacent output directions of the plurality of output directions.

24. The optical system of claim 1, wherein the optical system is a wavelength selective switch (WSS) comprising a plurality of input directions corresponding to one or more input ports, respectively, and a plurality of output directions corresponding to a plurality of output ports, respectively,
wherein the beam steering device is configured to reflect, with a first positive first-order reflection, the first polarized beam as a first reflected polarized beam on a third optical path toward the output,
wherein the beam steering device is configured to reflect, with a second positive first-order reflection, the second polarized beam as a second reflected polarized beam on a fourth optical path toward the output, and
wherein the optical arrangement is configured to provide, at the beam steering device, an angular offset between the first optical path and the second optical path such that the first reflected polarized beam and the second reflected polarized beam are output in the common output direction that is directed exclusively at a configured output port selected from the plurality of output ports.

25. The optical system of claim 24,
wherein the beam steering device is configured to reflect, with a first negative first-order reflection, the first polarized beam as a third reflected polarized beam on a fifth optical path toward the output,
wherein the beam steering device is configured to reflect, with a second negative first-order reflection, the second polarized beam as a fourth reflected polarized beam on a sixth optical path toward the output, and
wherein the optical arrangement is configured to provide, at the beam steering device, the angular offset between the first optical path and the second optical path such that the third reflected polarized beam and the fourth reflected polarized beam are output in one or more directions that are directed away from all of the plurality of output ports.

26. The optical system of claim 24,
wherein the beam steering device is configured to reflect, with a first second-order reflection, the first polarized beam as a third reflected polarized beam on a fifth optical path toward the output,
wherein the beam steering device is configured to reflect, with a second second-order reflection, the second polarized beam as a fourth reflected polarized beam on a sixth optical path toward the output, and
wherein the optical arrangement is configured to provide, at the beam steering device, the angular offset between the first optical path and the second optical path such that the third reflected polarized beam and the fourth reflected polarized beam are output in the one or more directions that are directed away from all of the plurality of output ports.

27. An optical system, comprising:
a beam steering device configured with a beam-steering dependency dependent on a linear polarization, wherein the beam steering device is configured to steer only light having the linear polarization; and
an optical arrangement comprising an input, a first optical path, and a second optical path, and an output, wherein the input is configured to receive an input beam with an arbitrary polarization state, and wherein the first optical path and the second optical path extend from the input and intersect at a same point-of-incidence on the beam steering device,
wherein the optical arrangement further comprises:
a polarization grating arranged at the input and the output, wherein the polarization grating is configured to split the input beam into two orthogonally polarized beams including a first polarized beam having a left circular polarization and a second polarized beam having a right circular polarization,
wherein the polarization grating is configured to direct the first polarized beam along the first optical path with the left circular polarization, and direct the second polarized beam along the second optical path with the right circular polarization;
a first mirror comprising a first retarder, wherein the first mirror is arranged on the first optical path between the polarization grating and the beam steering device, wherein the first mirror is configured to convert the left circular polarization of the first polarized beam into the linear polarization, and direct the first polarized beam further along the first optical path with the linear polarization; and
a second mirror comprising a second retarder, wherein the second mirror is arranged on the second optical path between the polarization grating and the beam steering device, wherein the second mirror is configured to convert the right circular polarization of the second polarized beam into the linear polarization, and direct the second polarized beam further along the second optical path with the linear polarization,
wherein the beam steering device is configured to steer the first polarized beam and the second polarized beam toward the output such that the first polarized beam and the second polarized beam are directed from the output in a common output direction.

28. The optical system of claim 27, wherein a first optical pathlength travelled by the first polarized beam from the input to the output is equal or substantially equal to a second optical pathlength travelled by the second polarized beam from the input to the output.

29. The optical system of claim 27, wherein the optical arrangement is configured such that the first optical path has a first number of reflections, and the second optical path has a second number of reflections that is equal to the first number of reflections or a difference between the first number of reflections and the second number of reflections is a multiple of two.

30. The optical system of claim 27, wherein the first mirror and the second mirror are configured such that the first polarized beam, with the linear polarization, and the second polarized beam, with the linear polarization, intersect at the same point-of-incidence with an intersection angle in a beam steering direction of the beam steering device.
